(19) United States
(12) Patent Application Publication
(10) Pub. No.: US 2012/0079474 A1
(43) Pub. Date: Mar. 29, 2012

(54) REIMAGING A MULTI-NODE STORAGE SYSTEM

(76) Inventors: Stephen Gold, Fort Collins, CO (US); Mike Fleischmann, Fort Collins, CO (US)

(21) Appl. No.: 12/889,709

(22) Filed: Sep. 24, 2010

(51) Int. Cl. G06F 9/445

(52) U.S. Cl. 717/173

(57) ABSTRACT

Reimaging a multi-node storage system is disclosed. An exemplary method includes downloading an upgrade image to a master node in the backup system. The method also includes pushing the upgrade image from the master node to all nodes in the backup system. The method also includes installing the upgrade image at each node while leaving an original image intact at each node in the backup system. The method also includes switching a boot marker to the upgrade image installed at each node in the backup system.

### BACKGROUND

Multiple files may be written as a single image file, e.g., according to the ISO 9660 standard or the like. These single image files are commonly used on installation and upgrade disks (e.g., CD or DVD disks). The single image file contains all of the data files, executable files, etc., for installing or upgrading program code (e.g., application software, firmware, or operating systems). The location of each individual file is specified according to a location or offset on the CD or DVD disk. Therefore, the user typically cannot access the contents of an image file from a computer hard disk drive by simply copying the image file to the hard disk drive. Instead, the contents of the image file must be accessed from the CD or DVD disk itself via a CD or DVD drive.

Upgrade disks permit easy distribution to multiple users. It is relatively easy to apply a standard upgrade using the upgrade disk because select files on the computing system are replaced with newer versions, and the device operating system is left largely intact following the upgrade. For major upgrades, however, the device operating system often has to be reinstalled. And in a multi-node device, every node has to be reinstalled at the same time in order to ensure interoperability after the upgrade.

Upgrading the operating system for a multi-node device can be complex because the user has to manually re-image each of the nodes individually (master nodes and slave nodes). This typically involves shutting down the entire system, and then connecting consoles and keyboards to every node (either one at a time or all nodes at one time), reimaging the node from the installation disk, manually reconfiguring the nodes, and then restarting the entire system so that the upgrade takes effect across the board at all nodes at the same time. This effort is time consuming and error-prone and may result in the need for so-called “support events” where the manufacturer or service provider has to send a technical support person to the customer's site to assist with the installation or upgrade.

### BRIEF DESCRIPTION OF THE DRAWINGS

FIG. 1 is a high-level diagram showing an exemplary multi-node storage system.

FIG. 2 is a diagram showing exemplary virtual disks in a multi-node storage system.

FIG. 3 is a flowchart illustrating exemplary operations for reimaging multi-node storage systems.

### DETAILED DESCRIPTION

Systems and methods for reimaging multi-node storage systems are disclosed. The reimaging upgrade can be installed via the normal device graphical user interface (GUI) “Software Update” process, and automatically reimages all the nodes and restores the configuration of each node without the need for user intervention or other manual steps. The upgrade creates a “recovery” partition with a “recovery” operating system that is used to re-image each node from itself.

In an exemplary embodiment, an upgrade image is downloaded and stored at a master node. The upgrade image is then pushed from the master node to a plurality of slave nodes. An I/O interface is configured to initiate installing the upgrade image at the plurality of slave nodes, while leaving an original image intact at the slave nodes. Then a boot marker is switched to the upgrade image installed at each of the plurality of slave nodes so that the upgrade takes effect at all nodes at substantially the same time.

Although the systems and methods described herein are not limited to use with image files, when used with image files, the a system upgrade may be performed to install or upgrade program code (e.g., an entire operating system) on each node in a multi-node storage system automatically, without the need to manually update each node separately.

Before continuing, it is noted that one or more node in the distributed system may be physically remote (e.g., in another room, another building, offsite, etc.) or simply “remote” relative to the other nodes. In addition, any of a wide variety of distributed products (beyond storage products) may also benefit from the teachings described herein.

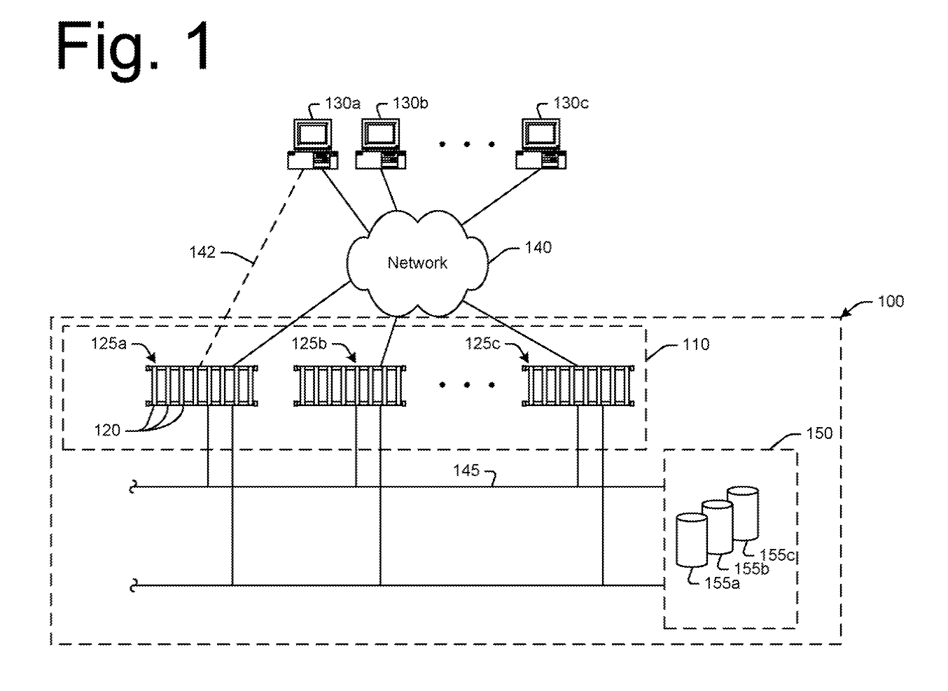

FIG. 1 is a high-level diagram showing an exemplary multi-node storage system 100. Exemplary storage system may include local storage device 110 and may include one or more storage cells 120. The storage cells 120 may be logically grouped into one or more virtual library storage (VLS) 125a-c (also referred to generally as local VLS 125) which may be accessed by one or more client computing device 130a-c (also referred to as “clients”), e.g., in an enterprise. In an exemplary embodiment, the clients 130a-c may be connected to storage system 100 via a communications network 140 and/or direct connection (illustrated by dashed line 142). The communications network 140 may include one or more local area network (LAN) and/or wide area network (WAN). The storage system 100 may present virtual libraries to clients via a unified management interface (e.g., in a “backup” application).

It is also noted that the terms “client computing device” and “client” as used herein refer to a computing device through which one or more users may access the storage system 100. The computing devices may include any of a wide variety of computing systems, such as stand-alone personal desktop or laptop computers (PC), workstations, personal digital assistants (PDAs), server computers, or appliances, to name only a few examples. Each of the computing devices may include memory, storage, and a degree of data processing capability at least sufficient to manage a connection to the storage system 100 via network 140 and/or direct connection 142.

In exemplary embodiments, the data is stored on one or more local VLS 125. Each local VLS 125 may include a logical grouping of storage cells. Although the storage cells 120 may reside at different locations within the storage system 100 (e.g., on one or more appliance), each local VLS 125 appears to the client(s) 130a-c as an individual storage device. When a client 130a-c accesses the local VLS 125 (e.g., for a read/write operation), a coordinator coordinates transactions between the client 130a-c and data handlers for the virtual library.

Redundancy and recovery schemes may be utilized to safeguard against the failure of any cell(s) 120 in the storage system. In this regard, storage system 100 may communicatively couple the local storage device 110 to the remote storage device 150 (e.g., via a back-end network 145 or direct connection). As noted above, remote storage device 150 may be physically located in close proximity to the local storage device 110. Alternatively, at least a portion of the remote storage device 150 may be “off-site” or physically remote from the local storage device 110, e.g., to provide a further degree of data protection.

Remote storage device 150 may include one or more remote virtual library storage (VLS) 155a-c (also referred to generally as remote VLS 155) for replicating data stored on one or more of the storage cells 120 in the local VLS 125. Although not required, in an exemplary embodiment, deduplication may be implemented for replication.

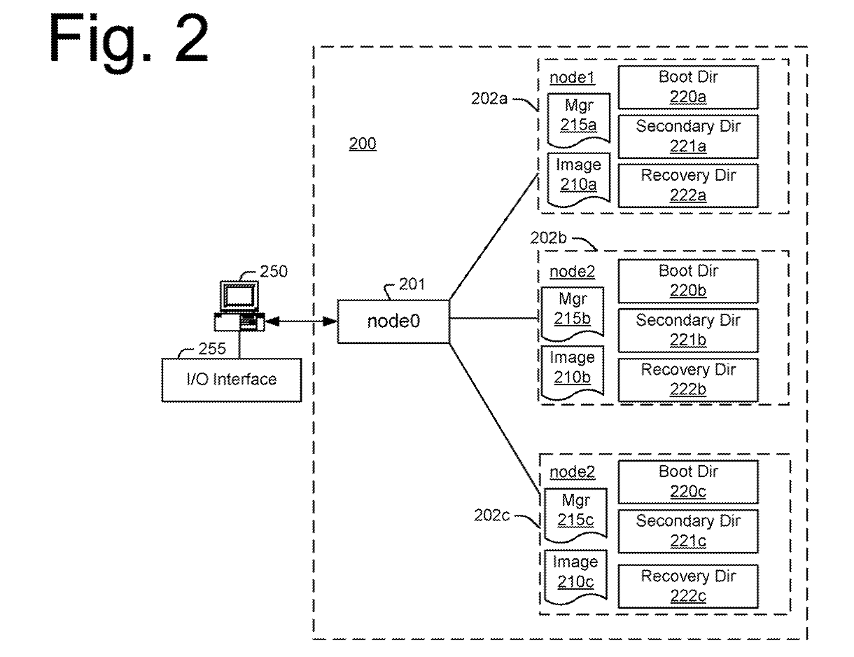

Before continuing, it is noted that the term “multi-node storage system” is used herein to mean multiple semi-autonomous “nodes”. Each node is a fully functional computing device with a processor, memory, network interfaces, and disk storage. The nodes each run a specialized software package which allows them to coordinate their actions and present the functionality of a traditional disk-based storage array to client hosts. Typically a master node is provided which may connect to a plurality of slave nodes, as can be better seen in FIG. 2.

FIG. 2 is a diagram showing exemplary nodes in a multi-node storage system 200. For purposes of illustration, the multi-node storage system 200 may be implemented in a VLS product, although the disclosure is not limited to use with a VLS product. Operations may be implemented in program code (e.g., firmware and/or software and/or other logic instructions) stored on one or more computer readable medium and executable by a processor in the VLS product to perform the operations described below. It is noted that these components are provided for purposes of illustration and are not intended to be limiting.

Each node may include a logical grouping of storage cells. For purposes of illustration, multi-node storage system 200 is shown including a master node 201 and slave nodes 202a-c. Although the storage cells may reside at different physical locations within the multi-node storage system 200, the nodes present distributed storage resources to the client(s) 250 as one or more individual storage device or “disk”.

The master node generally coordinates transactions between the client 250 and slave nodes 220a-c comprising the virtual disk(s). A single master node 201 may have many slave nodes. In FIG. 2, for example, master node 201 is shown having three slave nodes 202a-c. But in other embodiments, there may be eight slave nodes or more. It is also noted that a master node may serve more than one virtual disk.

In an embodiment, the upgrade may be initiated via a “Software Update” GUI or I/O interface 255 executing at the client device 250 (or at a server communicatively coupled to the multi-node storage device 200. The upgrade image (e.g., formatted as a compressed or a *.zip file) for the operating system in the boot directory 220a-c of each node 201 and 202a-c is loaded into the “Software Update Wizard” at the I/O interface 255 and downloaded to the master node 201 in a secondary directory or partition (e.g., also referred to as “/other” directory or partition). Alternatively, the user may select a check box (or other suitable GUI input) on the upgrade screen in the I/O interface 255 that instructs the master node 201 to read the image from the DVD drive coupled to the master node 201.

The image file may be an ISO 9660 data structure. ISO 9660 data structures contain all the contents of multiple files in a single binary file, called the image file. Briefly, ISO 9660 data structures include volume descriptors, directory structures, and path tables. The volume descriptor indicates where the directory structure and the path table are located in memory. The directory structure indicates where the actual files are located, and the path table links to each directory. The image file is made up of the path table, the directory structures and the actual files. The ISO 9660 specification contains full details on implementing the volume descriptors, the path table, and the directory. structures. The actual files are written to the image file at the sector locations specified in the directory structures. Of course, the image file is not limited to any particular type of data structure.

The upgrade image (illustrated as 210a-c) is pushed from the master node 201 to all of the plurality of slave nodes 202a-c. The upgrade image 210a-c is installed at each of the plurality of slave nodes 202a-c while leaving an original image intact at each of the plurality of slave nodes 202a-c. In an exemplary embodiment, a drive emulator may be provided as part of the upgrade image 210a-c to emulate communications with the disk controller at each of the nodes 202a-c. Drive emulator may be implemented in program code stored in memory and executable by a processor or processing units (e.g., microprocessor) on the nodes 202a-c. When in emulate mode, the drive emulator operates to emulate a removable media drive by translating read requests from the disk controllers into commands for redirecting to the corresponding offsets within the image file 210a-c to access the contents of the image file 210a-c. Drive emulator may also return emulated removable media drive responses to the nodes 202a-c. Accordingly, the image files may be accessed by the nodes 202a-c just as these would be accessed on a CD or DVD disk.

The upgrade image 210a-c contains an upgrade manager 215a-c (e.g., an upgrade installation script) and the upgrade components. During installation of the image 210a-c, the upgrade manager 215a-c unpacks upgrade image 210a-c, checks itself for errors, and performs hardware checks on all of the nodes 202a-c. The upgrade manager 215a-c may also include a one-time boot script which is installed on each of the nodes 202a-c.

The installation script may also perform various checks before proceeding with the upgrade. For example, the installation script may run a hardware check to ensure that there is sufficient hard drive space and RAM on the nodes 202a-c to perform the upgrade. If any check fails, the installation script causes the upgrade procedure to exit with an appropriate error message in the GUI at the I/O interface 255 (e.g., “Run an md5 verification of the upgrade contents,” “Check that all the configured nodes are online,” or the like).

If the upgrade checks pass, then the upgrade script installs the boot script. The boot script runs in all nodes 202a-c before any device services are started. Then all of the nodes 202a-c are rebooted. The boot script runs on each node 202a-c during reboot to prepare a recovery partition in each node 202a-c.

The recovery partition may be prepared in memory including one or more directory or partition. The terms “directory” and “partition” are used interchangeably herein to refer to addressable spaces in memory. For example, directories or partitions may be memory space (or other logical spaces) that are separate and apart from one another on a single physical memory. The directory or partition may be accessed by coupling communications (e.g., read/write requests) received at a physical connection at the node by a memory controller. Accordingly, the memory controller can properly map read/write requests to the corresponding directory or partition.

Before continuing, the boot script checks for the existence of a recovery partition 222a-c. If no recovery partition exists, then the boot script erases unnecessary log files and support tickets from the “/other” directory 221a-c. Alternatively, the boot script may shrink the current boot directory 220a-c to free up disk space, so that in either case, a new recovery partition 222a-c can be generated. The upgrade components can then be moved from the “/other” directory 221a-c to the recovery partition 222a-c, and the active boot partition 220a-c is changed to the recovery partition 222a-c. The current node ID (and any other additional configuration data) is saved as a file in the recovery partition 222a-c, and the nodes 202a-c are all rebooted into the respective recovery partitions 222a-c

Node configuration information is saved and then the node is rebooted from the recovery partitions 222a-c. At this point, the nodes 202a-c are each in a “clean” state (e.g., bare Linux is executing on each node, but there are no device services running), and reimaging can occur from the recovery partitions 222a-c.

Each node 202a-c is booted into the recovery partition 222a-c, which contains the quick restore operating system and firmware image. The quick restore process is executed from the recovery partition 222a-c to generate a RAM drive the same size as the recovery partition 222a-c, and then move the contents of the recovery partition 222a-c to the RAM disk. The quick restore process then reimages the node drives. It is noted that this process is different from using an upgrade DVD where the upgrade process waits for user input before reimaging.

If the re-imaging is successful, then the recovery partition 222a-c is mounted as the boot directory, and the contents of RAM drive are restored back to the recovery partition 222a-c. It is noted that this step is unique to the recovery partition process and is not run when using an upgrade DVD. In one embodiment, the upgrade manager 215a-c is configured to switch a boot marker to the upgrade image 210a-c installed at each of the plurality of slave nodes 202a-c. The distributed storage system 200 may then be automatically rebooted in its entirety so that each of the nodes 201 and 202a-c are rebooted to the new image 210a-c at substantially the same time. It is noted that this is different from using a DVD where the upgrade process waits for user input before rebooting.

At this point, each node 201 and 202a-c is rebooting from the reimaged firmware, and thus the nodes are in an unconfigured state. Accordingly, the node initialization process may be executed as follows. Node initialization checks for the existence of the node ID configuration file on the recovery partition 222a-c, and if it exists, then the node ID is automatically set. The node initialization process automatically restores the previous node IDs on all nodes 201 and 202a-c.

Initializing the master mode 201 utlizes a warm failover step that automatically recovers the device configuration and licenses. After warm failover is complete the node 201 is fully upgraded and is restored to its previous configuration and is fully operational.

Accordingly, a mechanism is provided for a major firmware upgrade (e.g., to the operating system) by applying a full reimaging of the device firmware without having to manually perform the re-imaging using a DVD on each node. The upgrade mechanism enables the firmware upgrade to be installed via the normal VLS device GUI ‘Software Update’ process, and then automatically reimages all the nodes and restores the configuration without any user intervention and without any manual steps. This improves the speed and reliability of the upgrade process for the VLS product, and also reduces manufacturer/service provider cost by enabling remote update, e.g., as compared to onsite manual re-imaging and reconfiguration of every node in a multi-node device with local consoles/keyboards.

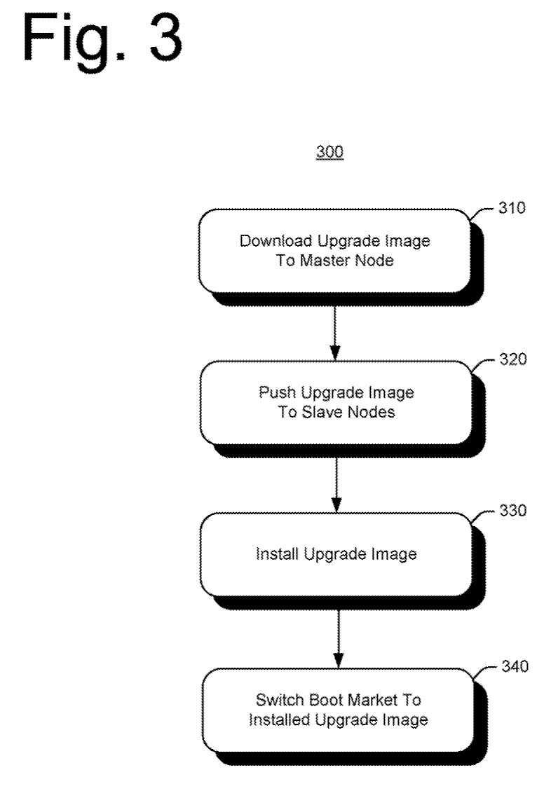

FIG. 3 is a flowchart illustrating exemplary operations for reimaging a multi-node storage system. Operations 300 may be embodied as logic instructions (e.g., firmware) on one or more computer-readable medium. When executed by a processor, the logic instructions implement the described operations. In an exemplary implementation, the components and connections depicted in the figures may be utilized.

In operation 310, an upgrade image is downloaded to a master node in the backup system. In operation 320, the upgrade image is pushed from the master node to all nodes in the backup system. In operation 330, the upgrade image is installed at each node while leaving an original image intact at each node in the-backup system. In operation 340, a boot marker is switched to the upgrade image installed at each node in the backup system.

By way of illustration, the method may further include determining whether the upgrade image is properly received at each node before installing the upgrade image. After installing the upgrade image, the method may also include determining whether the upgrade image is properly installed at each node before switching the boot marker to the upgrade image. The method may also include initiating a reboot on all nodes at substantially the same time after switching the boot marker to the upgrade image on each node.

Also by way of illustration, the method may include installing the upgrade image is in an existing secondary directory at each node. For example, the method may include installing the upgrade image in an existing support directory at each node. In another embodiment, the method may include “shrinking” an existing operating system directory at each node, and then creating a new operating system directory at each node in space freed by shrinking the existing operating system directory. The upgrade image may then be installed in the new operating system directory at each node.

The operations shown and described herein are provided to illustrate exemplary embodiments for reimaging a multi-node storage system. It is noted that the operations are not limited to the ordering shown and other operations may also be implemented.

It is noted that the exemplary embodiments shown and described are provided for purposes of illustration and are not intended to be limiting. Still other embodiments are also contemplated.

1. A method of reimaging a multi-node storage system, comprising:
downloading an upgrade image to a master node in the backup system;
pushing the upgrade image from the master node to all nodes in the backup system;
installing the upgrade image at each node while leaving an original image intact at each node in the backup system; and
switching a boot marker to the upgrade image installed at each node in the backup system.

2. The method of claim 1, further comprising determining whether the upgrade image is properly received at each node before installing the upgrade image.

3. The method of claim 1, further comprising determining whether the upgrade image is properly installed at each node before switching the boot marker to the upgrade image.

4. The method of claim 1, further comprising initiating a reboot on all nodes at substantially the same time after switching the boot marker to the upgrade image on each node.

5. The method of claim 1, wherein installing the upgrade image is in an existing secondary directory at each node.

6. The method of claim 1, wherein installing the upgrade image is in an existing support directory at each node.

7. The method of claim 1, further comprising:
shrinking an existing operating system directory at each node;
creating a new operating system directory at each node in space freed by shrinking the existing operating system directory; and
wherein installing the upgrade image is in the new operating system directory at each node.

8. A multi-node storage system, comprising:
a master node with computer-readable storage for storing a downloaded upgrade image and pushing the upgrade image to a plurality of slave nodes, each of the slave nodes having computer-readable storage for storing the upgrade image;
a program code product stored on computer readable storage at the master node and executable to:
initiate installing the upgrade image at each of the plurality of slave nodes while leaving an original image intact at each of the plurality of slave nodes; and
switch a boot marker to the upgrade image installed at each of the plurality of slave nodes.

9. The system of claim 8, wherein the upgrade image is downloaded at the master node from a removable storage medium connected to the master node but not connected to any of the slave nodes.

10. The system of claim 8, further comprising an upgrade manager stored in computer-readable storage at the master node and executable to:
determine whether the upgrade image is properly installed;
switch the boot marker to the upgrade image only if the upgrade image is properly installed; and
reinstall the upgrade image if the upgrade image is not properly installed.

11. The system of claim 10, wherein the upgrade manager is executable to initiate a reboot on all nodes at substantially the same time after switching the boot marker to the upgrade image on each node.

12. A program code product for reimaging a multi-node storage system, the program code product stored on computer-readable storage and executable to:
download an upgrade image to a master node;
push the upgrade image from the master node to a plurality of slave nodes, wherein the slave nodes unpack the upgrade image at each of the plurality of slave nodes, initiate installation of the upgrade image in at each of the plurality of slave nodes after checking that the upgrade image was properly received at each of the plurality of slave nodes, and switch a boot marker to the upgrade image installed at each of the plurality of slave nodes after checking that the upgrade image was properly installed at each of the plurality of slave nodes.

13. The program code product of claim 12, wherein the upgrade image is installed in an existing secondary directory or existing secondary partition at each node.

14. A program code product for reimaging a multi-node storage system, the program code product stored on computer-readable storage and executable to:
unpack an upgrade image received from a master node at each of a plurality of slave nodes;
initiate installation of the upgrade image in at each of the plurality of slave nodes after checking that the upgrade image was properly received at each of the plurality of slave nodes; and
switch a boot marker to the upgrade image installed at each of the plurality of slave nodes after checking that the upgrade image was properly installed at each of the plurality of slave nodes.

15. The program code product of claim 14, wherein the upgrade image is installed in an existing secondary directory or existing secondary partition at each node.

16. A multi-node storage system, comprising:
a plurality of slave nodes each with computer-readable storage for storing the upgrade image pushed from a master node to all of the plurality of slave nodes;
a program code product stored on computer readable storage and executable to:
install the upgrade image at each of the plurality of slave nodes while leaving an original image intact at each of the plurality of slave nodes, wherein a boot marker is switched to the upgrade image after the upgrade image is installed at each of the plurality of slave nodes.

17. The system of claim 16, further comprising an upgrade manager at each of the slave nodes, the upgrade manager unpacking the upgrade image and determining whether the upgrade image was received at each of the slave nodes without errors.

18. The system of claim 16, wherein the upgrade image is installed in an existing secondary directory at each node.
